(19) United States
(12) Patent Application Publication
(10) Pub. No.: US 2005/0217117 A1
(43) Pub. Date: Oct. 6, 2005

(54) Novel food slicer

(76) Inventor: Christofer Willis, Tucson, AZ (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/066,733

(22) Filed: Feb. 25, 2005

Related U.S. Application Data
(60) Provisional application No. 60/548,020, filed on Feb. 25, 2004.

(51) Int. Cl. A21C 5/08

(52) U.S. Cl. 30/114

(57) ABSTRACT

A utensil for cutting unique shapes in food comprising: a donut shaped member comprising a handle and a cutting blade; the cutting blade comprising an undulated contoured sheath terminating with a cutting edge, the contour imparting a novel and fanciful cutting design.

### Claim of Priority

This application claims priority of U.S. Ser. No. 60/548,020 filed Feb. 25, 2004.

### FIELD OF THE INVENTION

The present invention is directed to a system and apparatus for creating and cutting novel and unique sandwich shapes and the like.

### BACKGROUND OF THE INVENTION

Getting small children to eat is one of the more challenging aspects of parenting. Children tend to eat and accept food when the food and eating is presented as fun and a game. There have been a number of prior art technologies devoted toward providing and creating unique and unusual shapes for food.

U.S. Pat. No. 5,496,165 is a shaping cutter including upper and lower blades (4) and (3) fastened at one end so as to open in the shape of the letter X and cut when they close. The upper blade has an operating lever (6) extending from the end at which the upper and lower blades are fastened. An endless linear conveyor (2) has the lower blades fixed thereon, and a guide rod (7) extends parallel to the conveyor. When the conveyor moves, the operating levers of the upper blades slide along the guide rod to cause the upper blades to move from the opening position to the closing position relative to the lower blades, thereby cutting into pieces an elongated edible dough running at the same speed in the same direction as the endless linear conveyor runs. The elongated edible dough can be cut into pieces of a desired shape and size in succession.

U.S. Pat. No. 5,101,796 is a cut food piece formed in the shape of a helical split ring (10) by means of first cutting a slot in the whole food product by slot cutter (30) prior to urging the whole food product into engagement with cutter blade assembly (20) having wheel plate (21) rotating about central axis (23). Said cutter blade assembly (20) further having a plurality of ring cutters (24) attached to and extending normally out from wheel plate (21) for cutting continuous concentric helical spirals in the whole food product. Shear blade (25) extends angularly out from wheel plate (21) for cutting concentric helical rings of food product off the whole food product.

U.S. Pat. No. 6,474,210 is a slicing apparatus for slicing a food item having a flat bottomed base for placement upon a work surface; a bifurcated outer annulus attached to the base and extending perpendicularly upward from the base, the annulus having an arcuate slot formed on the peripheral centerline of the annulus; the annulus further having a first pair of diametric opposed knife attachment points formed on the inner surface of the annulus; an inner annulus located within the outer annulus and rotatable thereat, the inner annulus further having a second pair of diametrically opposed knife attachment points and an attached handle extending radially outward passing through the peripheral slot of the outer annulus; a left cover and a right cover, each cover having a convex circular outer surface and a concave circular inner surface, the periphery of the respective inner surfaces sized to matingly abut with the respective sides of the outer annulus, the covers further being pivotally attached to the base; an upper and a lower knife, each knife being arcuate in shape and having a cutting edge on the smaller diameter edge thereof, and further having a first end and a second end, each of the ends having an attachment point; each of the first ends being pivotally attached to a respective knife attachment point of the outer annulus and each of the second ends being pivotally attached to a respective knife attachment point of the inner annulus; whereby, movement of the handle through an arc rotates the inner annulus moving the knifes across the inner open part of the annuli and slices the food item.

U.S. Pat. No. 4,227,656 shows a pusher plate which pushes foodstuffs through the chute to the food processor in a vegetable slicer is divided, each portion being separately operable and having divider walls for selectively reducing the effective capacity of the chute to expedite handling of small and odd-sized foodstuffs.

U.S. Pat. No. 4,307,843 is a slicer for food products comprises a circular blade 2 mounted to rotate in a support-means 1, and a base 4 comprising a surface 5 for the accommodation of the product to be sliced, the said surface running substantially parallel with axis of rotation X-X′ of blade 2. Base 4 is hinged along axis Y-Y′ in relation to support-means 1 and comprises, at 8, a fractioning element, such as a grater and/or shaver, rotating about an axis Z-Z′ at right angles to surface 5 of base 4, the said axis being located in a plane at right angles to axis Y-Y′ of base 4 and passing through axis of rotation X-X′ of the blade. Fractioning element 9 is provided with means for coupling it, in rotation, to blade 2, after base 4 has been pivoted towards blade support means 1.

U.S. Pat. No. RE 36,155 discloses is directed to an apparatus for cutting a potato into a helical shape, the apparatus having a hollow, generally cylindrical body, a cutting plate having a top side and a bottom side located in the body for cutting a potato into a helical shape when a potato is inserted into the body, forced against the cutting plate and rotated around the longitudinal axis of the body, the cutting plate having a plurality of vertical blades for cutting a potato extending perpendicularly upward from the cutting plate and a horizontal blade located above the cutting plate for cutting a potato, and a feeding apparatus for forcing a potato onto the cutting plate and for rotating the potato about the longitudinal axis of the cylindrical body to cut the potato into a helical shape, and an apparatus for cutting an onion into a helical shape, the apparatus having a hollow, generally cylindrical body, a cutting plate having a top side and a bottom side located in the body for cutting an onion into a helical shape when an onion is inserted into the body, forced against the cutting plate and rotated around the longitudinal axis of the body, the cutting plate having a horizontal blade located above the cutting plate for cutting an onion, and a feeding apparatus for forcing an onion onto the cutting plate and for rotating the onion about the longitudinal axis of the cylindrical body to cut the onion into a helical shape.

German Patent No. 43 04 228, is directed to a vegetable slicer with an abutment face for the food to be sliced has a row of knives which is arranged transversely to the direction of movement of the food to be sliced and has vertically standing, mutually parallel knives oriented with the cutting edges towards the food to be sliced. At the end, above the abutment face and parallel thereto, a cutting knife is arranged in a second face (cutting face). In the cutting face, there is additionally arranged a second row of knives.

None of the prior art systems have shown and created a unique and novel method for providing unique and fanciful shapes for food, namely sandwiches and the like.

### OBJECTS AND SUMMARY OF THE INVENTION

It is an object of the present invention to provide a system for rapidly enabling unusual and fanciful shapes to be imparted to sandwich and other similar types of foods, thus making them more appealing to small children.

It is a further object of the present invention to provide a light weight. implement, preferable constructed from a lightweight polymer or plastic for cutting or imparting unique and fanciful shapes in foods such as sandwiches cakes and pizza.

It is a further object of the present invention to provide an implement which can be constructed in a number of eye appealing colors.

It is still a further object of the present invention to provide an implement which includes a hand guard and handle to protect the hand of the user.

It is still a further object of the present invention to provide an implement which can be easily stored with similar implements having different shaped cutters.

In accordance with the present invention, a utensil for cutting unique shapes in food comprising: a donut shaped member comprising a handle and a cutting blade; the cutting blade comprising an undulated contoured sheath terminating with a cutting edge, the contour imparting a novel and fanciful cutting design.

The design can comprise a multiplicity of shapes including serpentine, saw-tooth, zig-zag, stepped or the cartoon character. In one embodiment, the utensil comprises a polymer.

The present invention is directed to a utensil for cutting unique shapes in food comprising: a member comprising a handle and a cutting blade; the cutting blade comprising an undulated contoured sheath terminating with a cutting edge, the contour imparting a novel and fanciful cutting design.

In a further embodiment, the utensil for cutting unique shapes in food comprises a polymer member comprising a donut-shaped handle affixed to a cutting blade; the cutting blade comprising an undulated contoured sheath terminating with a cutting edge, the contour imparting a novel and fanciful cutting design.

Yet another embodiment of the present invention is a utensil for cutting unique shapes in food comprising: a polymer member comprising a handle and a cutting blade sharp edge; the cutting blade comprising an undulated contoured sheath terminating with a cutting edge, the contour imparting a novel and fanciful cutting design.

These and other objects and features of the present invention will become apparent from the detailed description which follows.

### BRIEF DESCRIPTION OF THE FIGURES

FIG. 1 is a perspective view of the slicer mechanism of the present invention.

FIG. 2 is a perspective view of the slicer profiles in accordance with the present invention.

FIG. 4 is an overhead view of sandwiches as cut by the present invention.

FIG. 3 illustrates a zig-zag type utensil in accordance with the present invention about to cut a sandwich.

### DETAILED DESCRIPTION OF THE PRESENT INVENTION

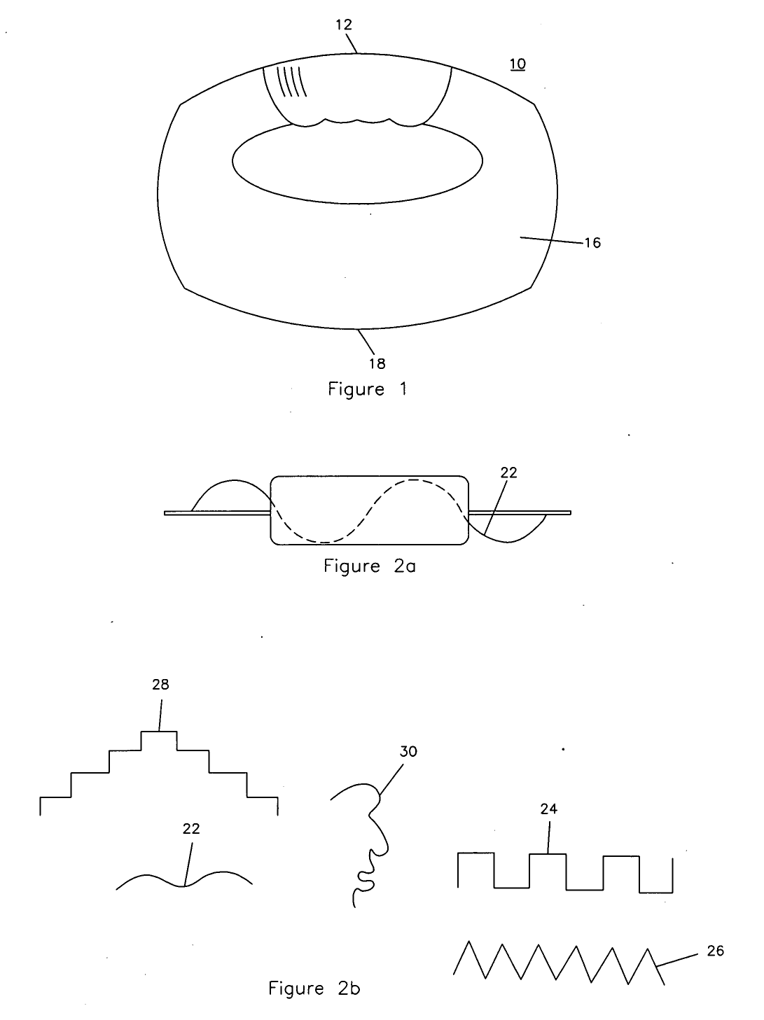

The present invention is described with reference to the enclosed Figures wherein the same numbers are utilized where applicable. Referring to FIG. 1, the invention, in a preferred embodiment, comprises a donut shaped member 10. The top of the member 10 comprises a handle 12 which permit the unit to be held. The lower potion below the handle comprises a cutting blade 14.

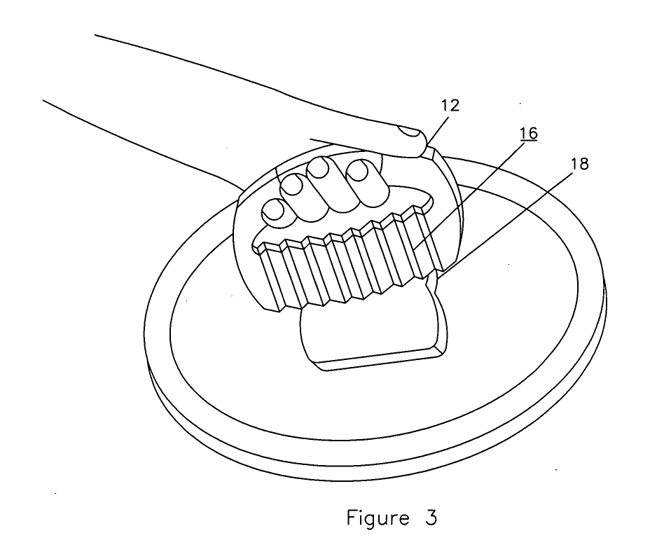

The cutting blade comprises a plastic sheath 16 with a sharp or bladed edge 18. As shown in FIG. 3, the sheath has an undulated contour 20 which is used to impart a novel and fanciful design. As shown in FIG. 2, the designs can comprise a multiplicity of shapes including serpentine 22, square-tooth 24, zig-zag 26, stepped 28 or even the shape of a cartoon or similar character 30.

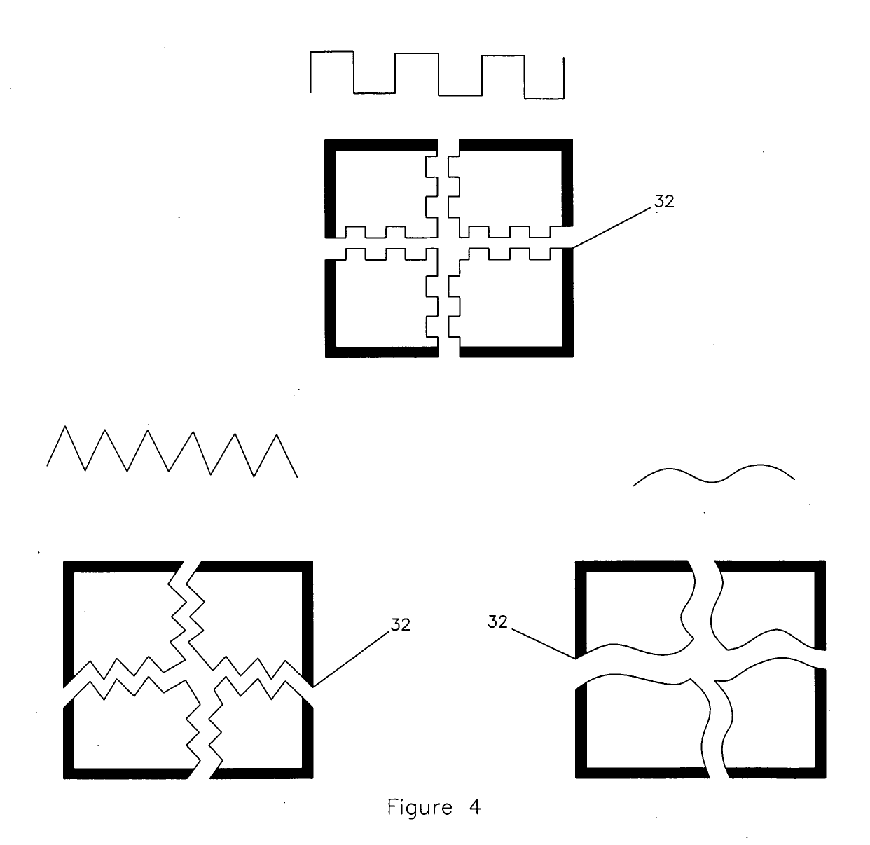

As shown in FIG. 4, the critical feature of the present invention is that it produces a unique and fanciful shape in cutting an item such as a sandwich 32, pizza or piece of fruit which is appealing to a child.

The invention may be constructed from a wide variety of materials including plastics, metals and the like. The implement may have a plurality of colors or may be transparent. It is to be appreciated that the present invention may be utilized at home, restaurants and in a multiplicity of food service and catering environments.

It is to be appreciated that the present invention has been described with reference to the enclosed Figures and the aforesaid detailed description. It is to be appreciated that other embodiments of the invention fulfill the spirit and scope of the invention and that true nature and scope of the invention is to be determined with reference to the claims add hereto.

1. A utensil for cutting unique shapes in food comprising:
a member comprising a handle and a cutting blade;
the cutting blade comprising an undulated contoured sheath terminating with a cutting edge, the contour imparting a novel and fanciful cutting design.

2. The utensil of claim 1 wherein the design can comprise a multiplicity of shapes including serpentine, saw-tooth, zig-zag, stepped, or a character.

3. The utensil of claim 1 wherein the handle is donut-shaped.

4. The utensil of claim 1 wherein the utensil comprises a polymer.

5. A utensil for cutting unique shapes in food comprising:
a polymer member comprising a donut-shaped handle affixed to a cutting blade;
the cutting blade comprising an undulated contoured sheath terminating with a cutting edge, the contour imparting a novel and fanciful cutting design.

6. A utensil for cutting unique shapes in food comprising:
a polymer member comprising a handle and a cutting blade sharp edge;
the cutting blade comprising an undulated contoured sheath terminating with a cutting edge, the contour imparting a novel and fanciful cutting design.

7. The utensil of claim 5 wherein the food is a sandwich.

8. The utensil of claim 5 wherein the food is a fruit.
